(19) United States
(12) Patent Application Publication
(10) Pub. No.: US 2018/0005603 A1
(43) Pub. Date: Jan. 4, 2018

(54) MANAGEMENT OF DISPLAY INPUTS

(71) Applicant: Hewlett-Packard Development Company, L.P., Houston, TX (US)

(72) Inventors: Shaheen Saroor, Houston, TX (US); Nam Nguyen, Houston, TX (US); Kent E Biggs, Tomball, TX (US)

(73) Assignee: Hewlett-Packard Development Company, L.P., Houston, TX (US)

(21) Appl. No.: 15/544,911

(22) PCT Filed: Apr. 17, 2015
(86) PCT No.: PCT/US15/26499

§ 371 Date: Jul. 20, 2017

(51) Int. Cl. G09G 5/14; G06F 3/14; G09G 5/00

(52) U.S. Cl. CPC G09G 5/14; G09G 5/006; G06F 3/1454; G09G 2370/16; G09G 2370/22; G09G 2370/12

(57) ABSTRACT

Examples relate to managing a display input An example system to manage a display input is provided herein. Management of display input includes a determination of a display mode selected. Management of display input also includes control of connections and transfer of data between an external device and an internal device. Management of display input further includes adjustment of a display setting based on display mode.

### BACKGROUND

A display device displays content from an electronic component Electronic components may be part of the display device and/or connected thereto. Examples of display devices include a monitor, a television, and/or a computing device, such as an all-in-one computer, a laptop computer, a tablet computing device, and a mobile phone.

### BRIEF DESCRIPTION OF THE DRAWINGS

The following detailed description references the drawings, wherein:

FIG. 1 illustrates a block diagram of a system to manage a display input according to an example;

FIGS. 2-3 illustrate block diagram of multiple input devices according to examples;

FIG. 4 illustrates a flow chart of a method to display content according to an example; and

FIG. 5 illustrates a schematic diagram of a system for managing multiple display inputs according to an example.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. Accordingly, the following detailed description does not limit the disclosed examples. Instead, the proper scope of the disclosed examples may be defined by the appended claims.

Using multiple electronic devices is common and sharing content between devices may increases a user's productivity. Current systems allow a user to connect a universal serial bus (USB) drive or external hard drive to an electronic device to view and edit content. Using devices such as a USB drive or external hard drive are typically intermediary devices used as part of a multiple phase process to view and transfer data between two user devices, such as a laptop and a tablet.

Comparison of content between multiple electronic devices is typically accomplished by placing two individual devices or display devices next to one another. For example, you may view and compare content from your laptop and your tablet by placing the display screen of the laptop and the display screen of the tablet next to one another. A method to view two devices on the same display device may be available: however, a user may only view content from one device at a time. For example, a user may view content from the laptop or tablet independently, but there is no way to view or compare the content of both devices on the same display device.

Examples relate to managing a display input. Management of display input includes a determination of a display mode selected. Management of display input also includes control of connections and transfer of data between an external device and an internal device. Management of display input further includes adjustment of a display setting based on display mode. As described below, management of display input enables content from multiple devices to be displayed on a single screen. Moreover management of display input may also enable content to be edited and transferred between devices.

As used herein, “display input” refers to a connection established between a display device and electronic devices. For example, a display input may include a display port, a video graphics array (VGA) port, a High-Definition Multimedia Interface (HDMI) port, a Wireless Display (WiDi) connection, Wireless Gigabit (WiGig) connection, or wireless local area network (WLAN),

As used herein, “display mode” refers to a selection of an electronic device to display content from. For example, a display mode may include an internal display mode, an external display mode, and a multiple display mode.

As used herein, “display setting” refers to a selection of at least one feature, preference, or operational characteristic. For example, display settings may include size, resolution quality, and type of window for content to be displayed.

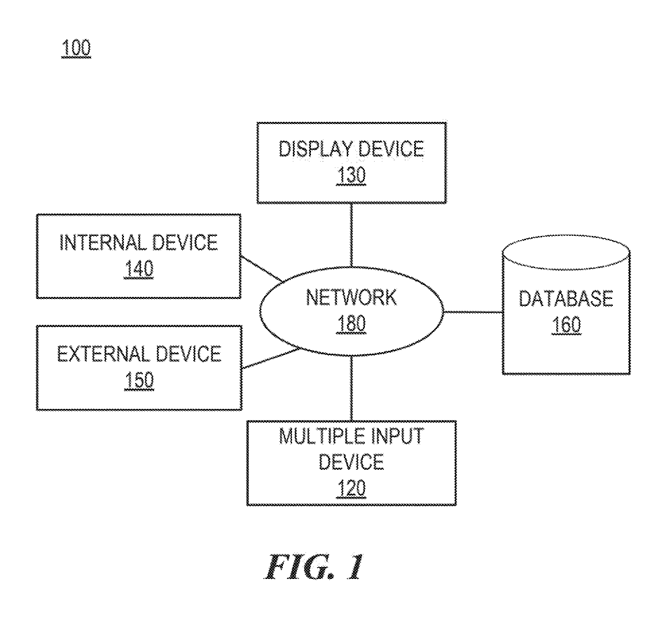

Referring now to the drawings, FIG. 1 illustrates a block diagram of a system to manage a display input according to an example. System 100 may be implemented in a number of different configurations without departing from the scope of the disclosed examples. In FIG. 1, system 100 may include a multiple input device 120, a display device 130, an internal device 140, an external device 150, a database 160, and a network 180 for connecting multiple input device 120 with database 160 and/or display device 130.

Multiple input device 120 may be a computing system that performs various functions consistent with disclosed examples, such as managing display inputs. For example, multiple input device 120 may be an all-in-one computer, a laptop computer, a tablet computing device, a mobile phone, a desktop computer, and/or any other type of computing device. In some examples, multiple input device 120 may determine a display mode selected. For example, the multiple input device 120 may determine if the display mode selected is an internal display mode, an external display mode, or a multiple display mode. The multiple input device 120 may be connected directly or indirectly to a toggle button and receive signals from the toggle button to select the display mode. The multiple input device 120 may also provide status notifications regarding the display mode selected.

Multiple input device 120 may also control connections and transfer of data between internal device 140 and external device 150. For example, multiple input device 120 may control connections and transfer of data between internal device 140 and external device 150. Multiple input device 120 may adjust a display setting based on the display mode. For example, multiple input device 120 may adjust the display setting based on the transfer of data between internal device 140 and external device 150.

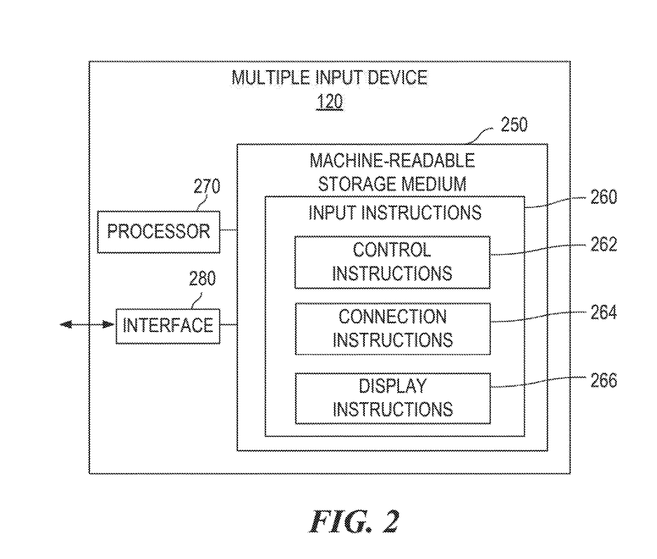

Multiple input device 120 may maintain, receive, transfer, or otherwise access data collections, such as display data, used to obtain, transfer, and display content for multiple input device 120. Multiple input device 120 may also collect, maintain, query, and/or analyze display data. For example, multiple input device 120 may provide access to actual content and/or settings. Multiple input device 120 may include a processor and may access, via the processor, display data of a data collection, such as display mode, display settings, and/or display content. Examples of multiple input device 120 and certain functions that may be performed by multiple input device 120 are described in greater detail below with respect to, for example, FIGS. 2-5.

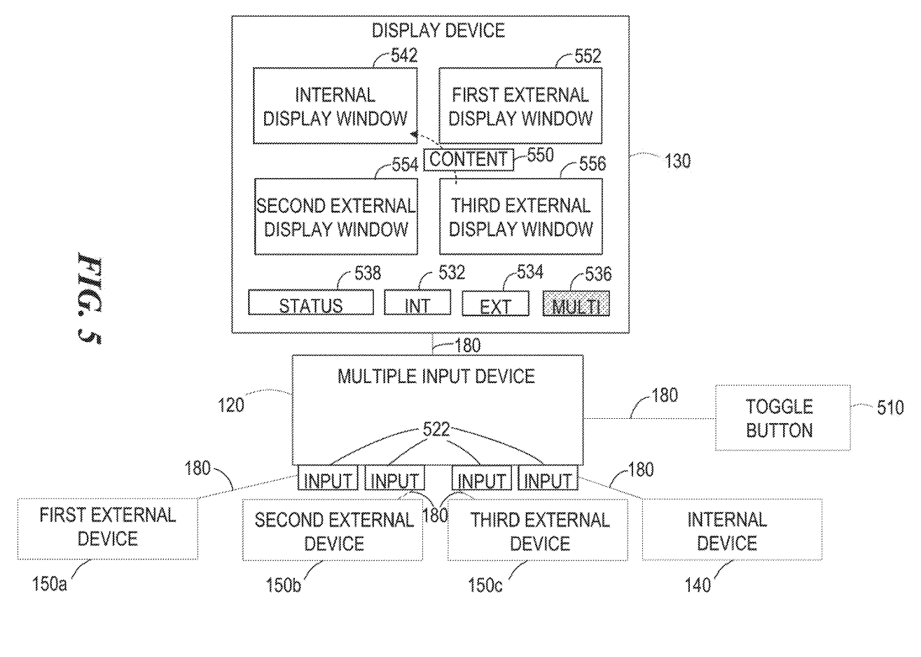

Display device 130 may be any device that displays content. For example, display device 130 may be a monitor, a television, and/or a computing device, such as an all-in-one computer, a laptop computer, a tablet computing device, a mobile phone, or any other type of computing device. Display device 130 may maintain, receive, transfer, or otherwise access display data, such as content to display, display settings, and display modes, used to display content based on data from multiple input device 120. For example, display device 130 may also receive, collect, maintain, query, and/or analyze content to display. Display device 130 may include a processor, and may access, via the processor, display data of the data collection, such as display mode, display settings, and/or content to display. Examples of display data are discussed in greater detail below with respect to, for example, FIG. 5.

Internal device 140 may be any device that maintains, receives, or transfers data from a data collection. Internal devices 140 may be integrated into display device 130 or connected to display device 130. For example, internal device 140 may be a scanning device or a computing device, such as a desktop computer, a laptop computer, a tablet computing device, a mobile phone, a server, or any other type of computing device. Internal device 140 may receive, transfer, or otherwise access data collections, such as display data used by multiple input device 120 and/or display device 130. For example, internal device 140 may provide access to display settings and/or content to display Internal device 140 may also collect, maintain, query, and/or analyze digital versions of content to display. Internal device 140 may include a processor, and may access, via the processor, display data, such as display modes, display data, and content to display. An example of internal device 140 includes a hard drive, memory device, and/or a storage device on a computing system native to the display device 130.

The external device 150 may be any device that maintains, receives, or transfers data from a data collection. For example, external device 150 may be a scanning device or a computing device, such as a desktop computer, a laptop computer, a tablet computing device, a mobile phone, a server, or any other type of computing device. External device 150 may receive, transfer, or otherwise access data collections, such as display data used by multiple input device 120 and/or display device 130. For example, external device 150 may provide access to display modes, display settings, and/or content to display. External device 150 may also collect, maintain, query, and/or analyze content to display. External device 150 may include a processor, and may access, via the processor, display data, such as display data and/or content to display. An example of external device 150 includes a laptop, a mobile phone, a tablet computing device, a server, or any other type of computing device

Database 160 may be any type of storage system configuration that facilitates the storage of data. For example, database 160 may facilitate the locating, accessing, and retrieving of data (e.g., SaaS, SQL, Access, etc. databases, XML files, etc.). Database 160 can be populated by a number of methods. For example, multiple input device 120 may populate database 160 with database entries generated by multiple input device 120, and store the database entries in database 160. As another example, multiple input device 120 may populate database 160 by receiving a set of database entries from another component, such as internal device 140 and/or external device 150; a wireless network operator, and/or a user of display device 130, and storing the database entries in database 160.

The database entries can contain a plurality of fields, which may include information related to display settings, display modes, and content to display. While in the example shown in FIG. 1 database 160 is a single component external to components 120 130 140, 150, database 160 may comprise separate databases and/or may be part of devices 120, 130, 140, 150, and/or another device. In some implementations, database 160 may be managed by components of devices 120 and/or 130 that are capable of accessing, creating, controlling and/or otherwise managing data remotely through network 180.

Network 180 may be any type of network that facilitates communication between remote components, such as multiple input device 120 and display device 130. For example, network 180 may be a local area network (LAN), a wide area network (WAN), a virtual private network,a dedicated intranet the Internet, and/or a wireless network.

The arrangement illustrated in FIG. 1 is simply an example and system 100 may be implemented in a number of different configurations. For example, while FIG. 1, shows one multiple input device 120, display device 130, internal device 140 external device 150 database 160, and network 180, system 100 may include any number of components 120, 130, 140, 150, 160, and 180, as well as other components not depicted in FIG. 1. System 100 may also omit any of components 120, 130, 140, 150, 160, and 180. For example, multiple input device 120, display device 130, and internal device 140 may be directly connected instead of being connected via network 180. As another example, multiple input device 120, display device 130, and internal device 140 may combined to be a single device.

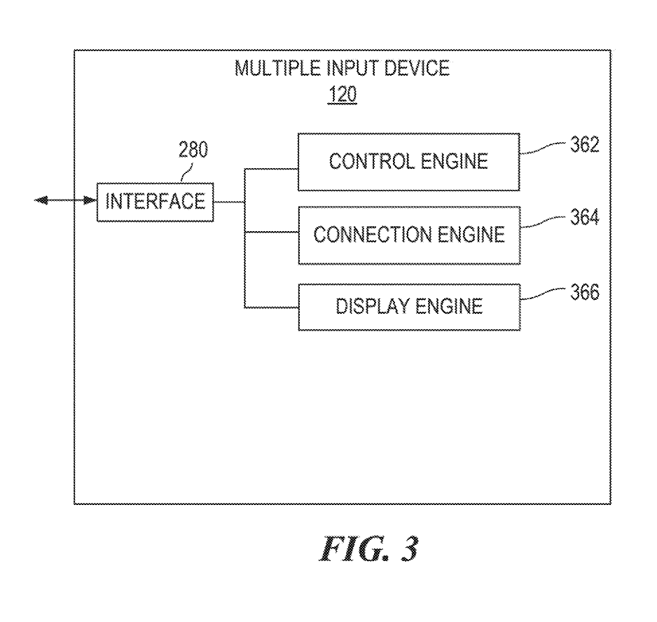

FIGS. 2-3 illustrate block diagrams of multiple input devices according to examples. Referring to FIG. 2, a multiple input device 120 is illustrated. In certain aspects, multiple input device 120 may correspond to multiple input device 120 of FIG. 1. Multiple input device 120 may be implemented in various ways. For example, multiple input device 120 may be a special purpose computer, a server, a mainframe computer, a computing device executing instructions that receive and process information and provide responses, and/or any other type of computing device. In the example shown in FIG. 2, multiple input device 120 may include a machine-readable storage medium 250, a processor 270, and an interface 280.

Processor 270 may be at least one processing unit (CPU), microprocessor, and/or another hardware device to execute instructions to perform operations. For example, processor 270 may fetch, decode, and execute input instructions 260 (e.g., instructions 262, 264, and/or 266) stored in machine-readable storage medium 250 to perform operations related to examples provided herein.

Interface 280 may be any device that facilitates the transfer of information between multiple input device 120 and other components, such as display device 130, internal device 140, external device 150, and/or database 160. In some examples, interface 280 may include a network interface device that allows the device to receive and send data to and from network 180. For example, interface 280 may retrieve and process data related to managing display input from database 160 via network 180.

Machine-readable storage medium 250 may be any electronic, magnetic, optical, or other physical storage device that stores executable instructions. Thus, machine-readable storage medium 250 may be, for example, memory, a storage drive, an optical disc, and/or the like. In some implementations, machine-readable storage medium 250 may be non-transitory, such as a non-transitory computer-readable storage medium, where the term “non-transitory” does not encompass transitory propagating signals. Machine-readable storage medium 250 may be encoded with instructions that, when executed by processor 270, perform operations consistent with the examples herein. For example, machine-readable storage medium 250 may include instructions that perform operations that provide manage display input by determining a display mode, manage a plurality of input connections, and monitoring data transfer between devices. In the example shown in FIG. 2, machine-readable storage medium 250 may include control instructions 262, connection instructions 264, and display instructions 266.

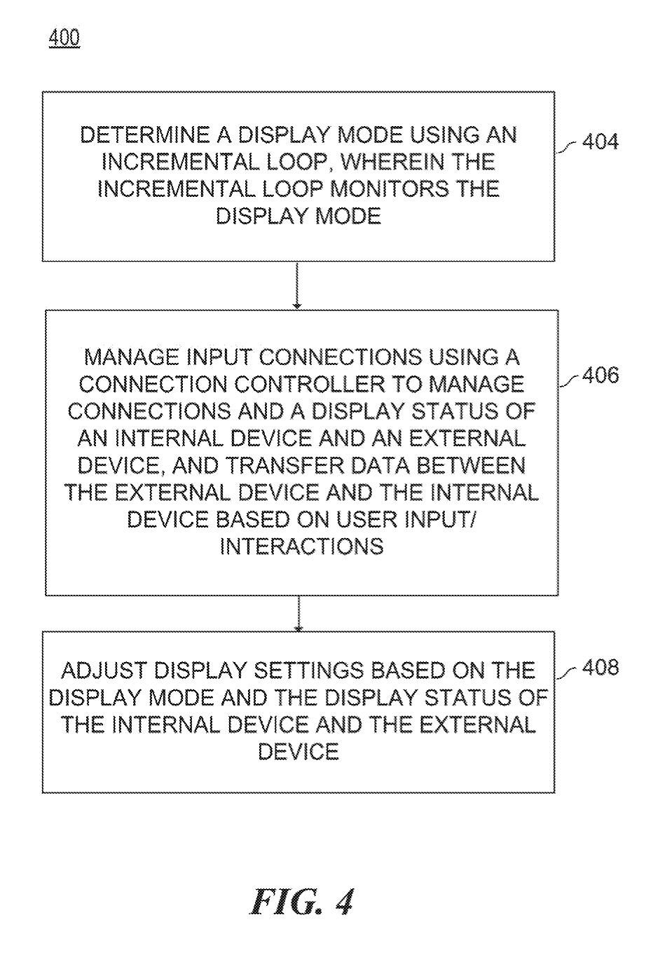

Control instructions 262 may function to determine a display mode selected based on an input. For example, when control instructions 262 are executed by processor 270, control instructions 262 may cause processor 270 of multiple input device 120, and/or another processor to determine a display mode. For example, the display mode may be an internal display mode, an external display mode, and a multiple display mode. The input may be determined using a loop to determine the display mode. The loop may circle between the display modes. The execution of the control instructions 262 may also cause processor 270 of multiple input device 120, and/or another processor to determine a display mode selected based on an input. Determination of a display mode is described in further detail below with respect to, for example, FIGS. 4-5.

Connection instructions 264 may function to manage a plurality of input connections based on the display mode. For example, when connection instructions 264 are executed by processor 270, connection instructions 264 may cause processor 270 of multiple input device 120, and/or another processor to identify external devices connected to an internal device, determine a display status for each of the plurality of input connections, and monitor data transfer between the external device and the internal device. Input connections include at least one connection selected from a display port, a video graphics array (VGA) port, a High-Definition Multimedia Interface (HDMI) port, a Wireless Display (WiDi) connection, Wireless Gigabit (WiGig) connection, or wireless local area network (WLAN) (such, as Wi-FiC®) connection. Management of a plurality of input connections based on the display mode are described in further detail below with respect to, for example, FIGS. 4-5.

Display instructions 266 may function to adjust a display setting. For example, when display instructions 266 are executed by processor 270, display instructions 266 may cause processor 270 of multiple input device 120, and/or another processor to adjust display settings. Adjustment of display settings may be based on the display mode selected and the display status of the each of the plurality of input connections. Adjustment of display settings may be performed automatically using data from multiple input device 120, display device 130, internal device 140 external device 150, and/or database 160. Adjustment of display settings may also be performed manually using user input. Adjustment of display settings may further be performed by a combination of data manually and automatically received. Adjustment of display settings are described in further detail below with respect to, for example, FIGS. 4-5.

Referring to FIG. 3, multiple input device 120 is illustrated to include a control engine 362, a connection engine 364 and a display engine 366. In certain aspects, multiple input device 120 may correspond to multiple input device 120 of FIGS. 1-2. Multiple input device 120 may be implemented in various ways. For example, multiple input device 120 may be a computing system and/or any other suitable component or collection of components that manage display inputs.

Interface 280 may be any device that facilitates the transfer of information between multiple input device 120 and external components. In some examples, interface'280 may include a network interface device that allows multiple input device 120 to receive and send data to and from a network. For example, interface 280 may retrieve and process data related to managing display inputs using data from multiple input device 120, display device 130, internal device 140, external device 150, and/or database 160.

Engines 362, 364, and 366 may be electronic circuitry for implementing functionality consistent with disclosed examples. For example, engines 362, 364, and 366 may represent combinations of hardware devices and instructions to implement functionality consistent with disclosed implementations. For example, the instructions for the engines may be processor-executable instructions stored on a non-transitory machine-readable storage medium and the hardware for the engines may include a processor to execute those instructions. In some examples, the functionality of engines 362, 364, and 366 may correspond to operations performed by multiple input device 120 of FIGS, 1-2, such as operations performed when input instructions 260 are executed by processor 270.

In FIG. 3, control engine 362 may represent a combination of hardware and instructions that perform operations similar to those performed when processor 270 executes control instructions 262. Similarly, connection engine 364 may represent a combination of hardware and instructions that perform operations similar to those performed when processor 270 executes connection instructions 264, and display engine 366 may represent a combination of hardware and instructions that perform operations similar to those performed when processor 270 executes display instructions 266.

FIG. 4 illustrates a flow chart of a process to manage display inputs according to examples. Although execution of process 400 is described below with reference to system 100, other suitable systems and/or devices for execution of at least one block of process 400 may be used. For example, processes described below as being performed by system 100 may be performed by multiple input device 120, display device 130, internal device 140, and/or any other suitable device or system. Process 400 may be implemented in the form of executable instructions stored on a storage device, such as a machine-readable storage medium, and/or in, the form of electronic circuit,

Referring to FIG, 4, a method to display content according to an example is provided. Process 400 may start by determining a display mode using a loop to monitor the display mode (block 404) For example, the display mode may be determined by prompting a user to select the display mode when an external device is connected. Alternatively, the display mode may he determined by querying each input port to manage connections. For example, multiple input device 120 and/or display device 130 of system 100 may query or otherwise access database 160 stored in a storage device, such as database 160.

Process 400 may also include managing input connections using a connection controller (block 406). Connection controller may manage connections and a display status of an internal device and an external device. For example, multiple input device 120 and/or display device 130 may monitor input connections through the connection controller. The connections and display status data may be stored in a storage device, such as database 160, and multiple input device 120 and/or display device 130 may query database 160 to obtain connection and display status data.

Connection controller may also transfer data between the external device and the internal device based on user input. For example, multiple input device 120 and/or display device 130 may manage transfer of data between the external device and the internal device based on user input through the connection controller. Data related to the transfer and user input may be stored in a storage device, such as database 160, and multiple input device 120 and/or display device 130 may query database 160 to obtain data related to the transfer and user input. In a further example, multiple input device 120 and/or display device 130 may also display notifications regarding status of external devices.

Process 400 may also include adjusting display settings based on the display mode and the display status of the internal device and the external device block 408). For example, multiple input device 120 and/or display device 130 may adjust display settings. Display settings may be adjusted to divide a portion of a display device to display content from at least two devices. The set of display settings include settings for an internal display mode, an external display mode, and a multiple display mode. Display settings may be stored in a storage device, such as database 160, and multiple input device 120 and/or display device 130 may query database 160 to obtain display settings.

FIG. 5 illustrates a schematic diagram of a system 500 for managing multiple display inputs according to an example. Referring to FIG. 5, an example of an approach to manage display input using system 500 includes a multiple input device 120, a display device 130, an internal device 140, and three external devices 150a-1500 connected via any type of network 180.

Multiple input device 120 may include control engine 362, connection engine 364, and display engine 366, as described above with reference to FIG. 3. Multiple input device 120 may determine a display mode selected. The display mode may be at least one mode selected from an internal display mode 532, an external display mode 534, and a multiple display mode 536. For example, control engine 362 may determine a display mode.

The display mode may be selected by a user. For example, using to a toggle button 510 connected to control engine 362 such that the control engine 362 receives signals from toggle button 510 and/or transmits signals to toggle button 510. Toggle button 510 may be on the display as part of the user interface, a hard button on the monitor, on the keyboard, and/or on a native device, such as a personal computer. Toggle button 510 may loop or circle through the display modes. In an example, pressing the toggle button 510 once may select internal display mode 532 where content from internal device 140, such as a PC, is the only content displayed. Pressing the toggle button 510 a second time, may select external display mode 534, which displays content from external device 150, such as an attached smartphone or tablet, and does not display content from internal device 140. Pressing the toggle button 510 a third time, may select multiple display mode 536, which enables display of content from internal device 140 and external device 150 simultaneously on one display device or screen segmented for each device As illustrated in FIG. 5, segments may be in the form of windows on display device 130 and a picture in picture type display that has been used with televisions. FIG. 5 includes four segments or windows, as such, multiple display mode 536 is highlighted on the display device 130.

In another example, a user may be prompted to select a display mode when an external device is connected. Alternatively, determination of the display mode may be automatically determined by the multiple input device 120. For example, control engine 362 may query each input port and manage connections based on results of the query. Control engine 362 may also provide status notifications 538, such as specific and/or general notifications regarding devices connected to display device 130 and status or settings of each device. Examples of status notifications include information stating the name or type of device connected/disconnected, a signal strength, i.e., for a wireless connection; and a compatibility message related to hardware and/or software, such as fully compatible, limited compatibility, and not compatible. As illustrated in FIG. 5, the notifications regarding status of internal and/or external devices may be displayed on display device 130. Status notifications 538 may be provided in addition to display mode information provided as reference numbers 532, 534, 536.

Continuing with the example of FIG. 5 multiple input device 120 may also control connections and transfer of data between an external device and an internal device. The connections may be controlled using, for example, a table or list of external devices and status of each device. For example, a connection engine 364 may control connections, such as input connections 522 from wired connections through a display port, a video graphics array (VGA) port, and a High-Definition Multimedia Interface (HDMI) port.

For instance, a display port input may include a notebook connected to a personal computing device via a display port on the personal computing device. The display port on a personal computing device, i.e., native device, would need to have a minimum of two lanes from a personal computer processor to drive a native display. Multiple input device 120 s witches the video path from internal processor to external display port input. In internal display mode 532 both internal process display port paths are enabled for rendering on display device 130 and an external path is blocked. In external display mode 534, the external display port path is open and selected for rendering on display device 130 and internal display port path is disabled. In multiple display mode 536, one lane of internal processor display port is enabled and a path from external display port is selected and enabled for rendering on display device 130. Content from the internal and external devices will be displayed and may be edited on the display and/or transferred between devices.

In another example, a notebook may be connected to a personal computing device via a VGA or an HDMI input. In this example, there are no minimum number of display port lanes from a personal computer processor to drive the native display. In internal display mode 532, internal processor display port path is enabled, and external display port path is disabled or blocked. In external display mode 534, the external display port path is open and selected for rendering on display device 130 and internal display port path is disabled. In multiple input mode 534, both internal processor display port path and external display port path from the VGA or HDMI input are enabled and selected for rendering on the display device 130, i.e., personal computer screen.

In the display port, VGA, and HDMI input examples above, display modes may be switched using manual and/or automatic methods discussed above. Input connections controlled by the connection engine 364 may also include wireless connections, such as a Wireless Display (WiDi), Wireless Gigabit (WiGig), or wireless local area network (WLAN) (such as Wi-Fie) connection. Any device broadcasting display content via wireless display technologies may become another window on display device 1301 Content the internal and external devices will be displayed and may be edited on the display and/or transferred between devices.

Transfer of data between an external device and an internal device may also be controlled via connection engine 364. For example, data from first external device 150a may be transferred to internal device 140. Referring to FIG. 5, display device 130 content 550 may be transferred using a mouse with click, drag, and drop functionality and/or a copy and paste functionality further described below.

Multiple input device 120 may also adjust display settings. For example, display engine 366 may adjust a display setting based on the display mode. Display settings include settings for an internal display mode, an external display mode and a multiple display mode. Adjustments to display, settings may include dividing a portion of a display device to display content from at least two devices.

Referring to the example of FIG. 5, display device 130 is divided into four sections, an internal display window 542, a first external display window 552, a second external display window 554, and a third external display window 556. Display device 130 may also be divided into more than four or fewer than four sections depending on the devices connected to the multiple input device and the display mode selected. Depending on the display mode and devices the display setting may be adjusted. Moreover, multiple input device 120 may be used to transfer of data between internal device 140 and/or external devices 150a-150c. The transfer of data may be handled by the multiple input device 120 and display settings that enable the content 550 to transfer and be displayed on display device 130. For example, click, drag, and drop functions with a mouse may be used to transfer a file between third external display window 556 and internal display window 542. In another example, a user may edit content of one or more of the display windows while the content of the other display windows is simultaneously visible to a user. System 500 enables multiple devices on the same screen with quick access to data that enables data to be switched, modified, and interactions to occur in a way that increases productivity.

The disclosed examples may include systems, devices computer-readable storage media, and methods for managing display inputs. For purposes of explanation, certain examples are described with reference to the components illustrated in FIGS. 1-3. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by this terms. Instead, these terms are used to distinguish one element from another.

Further, the sequence of operations described in connection with FIGS. 1-5 are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this application and protected by the following claims.

We claim

1. A system to manage a display input comprising:
a control engine to determine a display mode selected;
a connection engine to control connections and transfer of data between an external device and an internal device and
a display engine to adjust a display setting based on the display mode.

2. The system of claim 1, wherein the display engine is further to adjust the display setting based on the transfer of data between the internal device and the external device.

3. The system of claim 1, wherein the control engine is to provide status notifications.

4. The system of claim 1, wherein the control engine is to select the display mode from at least one mode selected from an internal display mode, an external display mode, and a multiple display mode.

5. The system of claim 1, wherein the control engine is connected to a toggle button and receives signals from the toggle button.

6. A computer-readable storage medium encoded with instructions that, when executed by a processor performs a method, causes the processor to:
determine a display mode selected based on an input;
manage a plurality of input connections based on the display mode, management includes:
identifying external devices connected to an internal device,
determining a display status for each of the plurality of input connections, and
monitoring data transfer between the external device and
the internal device; and
adjust a display setting based on
the display mode selected, and
the display status of the each of the plural of input connections.

7. The computer-readable storage medium o claim 6 wherein the input connections include at least one connection selected from a display port, a video graphics array (VGA) port and a High-Definition Multimedia Interface (HDMI) port.

8. The computer-readable storage medium of claim 6, wherein the input connections include at least one wireless connection selected from a Wireless Display (WiDi), Wireless Gigabit (WiGig), or wireless local area network (WLAN) (such as Wi-Fie) connection.

9. The computer-readable storage medium of claim herein the input use a loop to determine the display mode.

10. A method to display content comprising:
determining a display mode using a loop to monitor the display mode,
managing input connections using a connection controller to
manage connections and a display status of an internal device and an external device, and
transfer data between the external device and the internal device based on user input; and
adjusting a set of display settings based on the display mode and the display status of the internal device and the external device,

11. The method of claim 10, further comprising prompting a user to select he display mode when the external device is connected.

12. The method of claim 10, further comprising querying each input port to manage connections.

13. The method of claim 10, wherein the display settings divide a portion of a display device to display content from at least two devices.

14. The method of claim 10, wherein the set of display settings include settings for an internal display mode, an external display mode, and a multiple display mode.

15. The method of claim 10, further comprising displaying notifications regarding status of external devices.
